(19) United States
(12) Patent Application Publication
(10) Pub. No.: US 2012/0112635 A1
(43) Pub. Date: May 10, 2012

(54) LIGHT SYSTEM FOR A BICYCLE AND METHOD OF CONTROLLING THE SAME

(76) Inventors: Kil Hwan Cho, Busan (KR); Se Yun Kim, Gyeonggi-do (KR)

(21) Appl. No.: 13/088,613

(22) Filed: Apr. 18, 2011

(30) Foreign Application Priority Data
Nov. 4, 2010 (KR) 10-2010-0108981

(51) Int. Cl. B60Q 1/30; B60Q 1/34; B60Q 1/32

(52) U.S. Cl. 315/79; 315/77

(57) ABSTRACT

In a light system for a bicycle, a body is detachably installed to a frame of the bicycle. A battery is installed in the body and a first light source is positioned at a central portion of the body and shines a flashlight. A second light source is positioned at a side portion of the body and shines a light beam displaying a bicycle lane on a riding surface. A sensor detects a stop or a riding of the bicycle. A controller controls the first and the second light sources in accordance with the sensor. The first and the second light sources are turned on in riding the bicycle and turned off in stopping the bicycle. Accordingly, the light system is automatically turned on/off according to the riding and stopping of the bicycle.

### CROSS-REFERENCE TO RELATED APPLICATIONS

This application claims the benefit of Korean Patent Application No. 10-2010-0108981, filed on Nov. 4, 2010, in the Korean Intellectual Property Office, the disclosure of which is incorporated herein in its entirety by reference.

### BACKGROUND

1. Field

Example embodiments relate to a light system for a bicycle and method of controlling the same, and more particularly, to a light system for the bicycle having a rear light and a pair of tail lights and method of controlling the same.

2. Description of the Related Art

Recently, various bicycle safety accidents have been generated much more frequently according to rapid increase of the bicycle ride. However, since the bicycle is usually driven manually and has no sufficient power generation system, the bicycle is difficult to be distinguished from surroundings at night.

For solving the above handicaps of the bicycle, a tail light system for a bicycle has been suggested in which a streak of light beams shines from the tail light system on the bicycle's riding surface and thus displays a minimal safe passing area across a left portion to a right portion of the bicycle, as disclosed in U.S. Patent Application Publication No. 2008-0219014, entitled as “Bicycle bumper with a light generating bike lane”, in an article at a website of http://www.engadet.com/light-lane-concept-would-protect-cyslists-bring-tron-to-life/#comments (2009.01.16) and of http://design-enter.com/tt/2047 (2009.06.20) and in Korean Patent No. 959,262 issued on May 14, 2010 and published on May 26, 2010.

FIG. 1 is a picture showing the conventional tail light system for a bicycle and FIG. 2 is another picture showing the conventional tail light system for a bicycle. FIGS. 1 and 2 are captured from internet websites.

As shown in FIGS. 1 and 2, a laser diode or a light emission diode (LED) is installed to the bicycle and light beams are irradiated on the bicycle's riding surface from the laser diode as a bike lane to thereby display a minimal safe passing area across the left portion to the right portion of the bicycle. Therefore, the bicycle and cyclist on the bicycle are sufficiently discriminated from surroundings.

However, the laser diode or the LED in the conventional tail light system may require a large amount of driving power and thus the light beams are difficult to be irradiated for a sufficiently long time and the optical bike lane is displayed for a short time within the battery capacity.

In addition, when the cyclist is fallen down in riding the bicycle, the laser for displaying the optical bike lane is still irradiated from the diode, which causes critical damages to an eye of the passers-by around the bicycle.

### SUMMARY

Example embodiments provide a light system for a bicycle in which the power consumption is sufficiently reduced.

Other example embodiments provide a light system for a bicycle in which the light sources for displaying the optical bike lanes also function as turn indicators of the bicycle and a method of controlling the light system.

Other example embodiments provide a light system for a bicycle in which the light sources are turned on or off in accordance with the moving state of the bicycle.

Other example embodiments provide a light system for a bicycle in which the laser for displaying the bike lane is not irradiated when the cyclist is fallen down to thereby prevent the damages to the eyes of the passers-by caused by the laser.

According to some example embodiments, there is provided a light system for a bicycle. The light system for a bicycle may include a body detachably installed to a frame of the bicycle, at least a battery installed in the body, a first light source positioned at a central portion of the body and shining a flashlight to a rear side of the bicycle, a second light source positioned at a side portion of the body and shining a light beam displaying a bicycle lane on a riding surface of the bicycle, a sensor installed in the body and detecting a stop or a riding of the bicycle and a controller installed in the body and controlling the first and the second light sources in accordance with the sensor in such a manner that at least one of the first and the second light sources is turned on in riding the bicycle and is turned off in stopping the bicycle. In an example embodiment, the sensor may include an inertial sensor, an acceleration sensor, a vibration sensor and a motion sensor.

According to some example embodiments, there is provided another light system for a bicycle. The light system for a bicycle may include a body detachably installed to a frame of the bicycle, at least a battery installed in the body, a first light source positioned at a central portion of the body and shining a flashlight to a rear side of the bicycle, a pair of left and right second light sources positioned at both side portions of the body and shining a light beam displaying a bicycle lane on a riding surface of the bicycle, a geomagnetic sensor built in the body and detecting a turning of the bicycle leftwards or rightwards and a controller installed in the body and controlling the second light sources in accordance with the geomagnetic sensor in such a manner that one of the left and right second light sources blinks according to a turning direction when the bicycle turns leftwards or rightwards and stops to blink and shines the light beam displaying the bicycle lane when the bicycle completes the leftward or rightward turning.

According to some example embodiments, there is provided still another light system for a bicycle. The light system for a bicycle may include a body detachably installed to a frame of the bicycle, at least a battery installed in the body, a first light source positioned at a central portion of the body and shining a flashlight to a rear side of the bicycle, a pair of left and right second light sources positioned at both side portions of the body and shining a light beam displaying a bicycle lane on a riding surface of the bicycle, a first sensor built in the body and detecting a stopping or a riding of the bicycle, a second sensor built in the body and detecting a moving direction of the bicycle, and a controller installed in the body and controlling the first and the second light sources in accordance with the first and the second sensors in such a manner that at least one of the first and the second light sources is turned on in riding the bicycle and is turned off in stopping the bicycle and one of the left and right second light sources blinks according to a turning direction when the bicycle turns leftwards or rightwards and stops to blink and shines the light beam displaying the bicycle lane when the bicycle completes the leftward or rightward turning. In an example embodiment, the first sensor may include an inertial sensor, an acceleration sensor, a vibration sensor and a motion sensor and the second sensor may include a geomagnetic sensor.

According to some example embodiments, there is provided further still another light system for a bicycle. The light system for a bicycle may include a body detachably installed to a frame of the bicycle, at least a battery installed in the body, a pair of turn indicators positioned at both side portions of the body and creating a turn signal according to a turning of the bicycle leftwards or rightwards, a directional sensor built in the body and detecting the turning of the bicycle leftwards or rightwards, and a controller installed on a control circuit board in the body and controlling the turn indicators in accordance with the directional sensor in such a manner that one of the turn indicators blinks according to a turning direction when the bicycle turns leftwards or rightwards and stops to blink and shines a light beam at a rear side of the bicycle when the bicycle completes the leftward or rightward turning.

According to some example embodiments, there is provided a method of controlling the light system for a bicycle. A moving direction of the bicycle may be detected by a sensor and a direction change with respect to the detected moving direction may also be detected by the same sensor. A control signal may be generated corresponding to the direction change by a controller. A respective turn indicator may be blinked according to the control signal when the bicycle changes the moving direction. When the direction change of the bicycle is not any more detected for a predetermined time by the sensor, the respective turn indicator may stop blinking and may shine a light beam to a rear side of the bicycle.

According to some example embodiments of the present inventive concept, the light system for a bicycle includes a first light source that may be automatically turned on or off without any additional manual operations according as the bicycle rides. That is, the first light source may be automatically turned off when the bicycle stops and turned on when the bicycle starts to ride, thereby reducing the power consumption for the first light source. In addition, the light system may also include a second light source that may generate turn signals as well as the bike line and no additional turn indicators may be required for blinking turn signals, thereby preventing various bicycle safety accidents. Further, the second light sources may function as the turn indicator that may be automatically operated in accordance with the direction change of the bicycle by the sensor and the controller, thereby facilitating the bicycle driving.

### BRIEF DESCRIPTION OF THE DRAWINGS

Example embodiments will be more clearly understood from the following detailed description taken in conjunction with the accompanying drawings.

FIG. 1 is a picture showing the conventional tail light system for a bicycle;

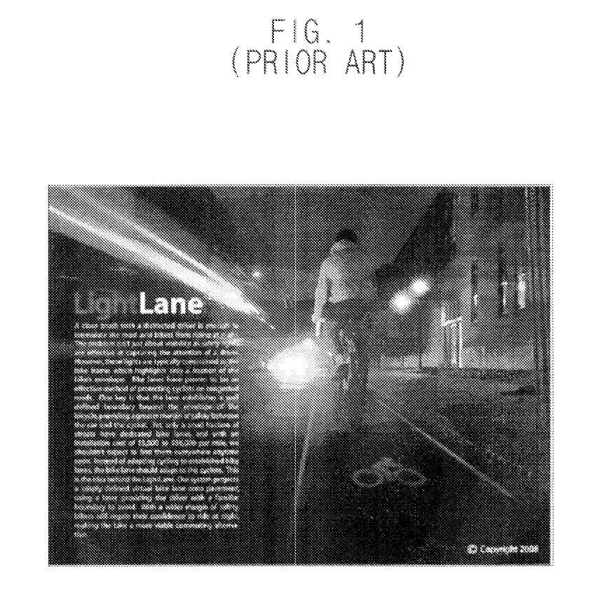

FIG. 2 is another picture showing the conventional tail light system for a bicycle;

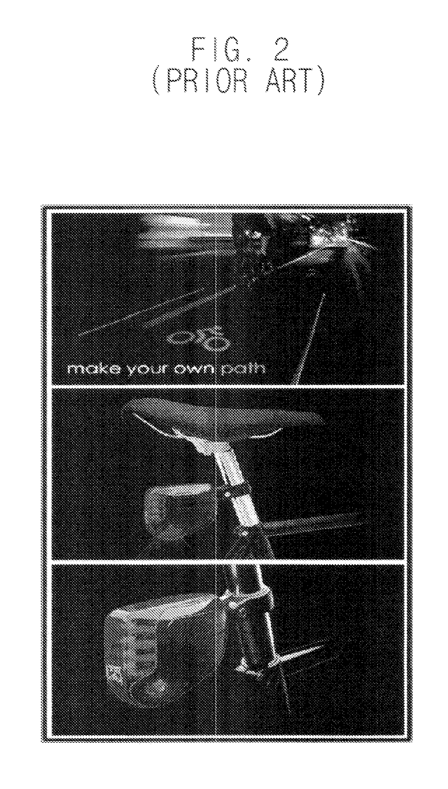

FIG. 3 is a view illustrating a light system for a bicycle in accordance with an example embodiment of the present inventive concept;

FIG. 4 is a block diagram showing a control circuit of the controller for operating the light system illustrated in FIG. 3; and

FIG. 5 is a timing flow diagram showing the operation of the control circuit of the controller for operating the light system of the bicycle.

### DETAILED DESCRIPTION OF THE EMBODIMENTS

Various example embodiments will be described more fully hereinafter with reference to the accompanying drawings, in which some example embodiments are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings. A deposition apparatus for forming a thin layer on a semiconductor substrate such as a wafer may be provided as an example of an apparatus for processing a substrate hereinafter. However, the deposition apparatus is merely illustrative example embodiment and is not to be construed as limiting thereof. Thus, the lift pin of the present example embodiment of the present inventive concept may also be applied to various apparatus for processing the substrate such as a dry etching apparatus, a planarization apparatus and an ion implantation process just under condition that the process is performed onto the substrate positioned on a susceptor in the apparatus.

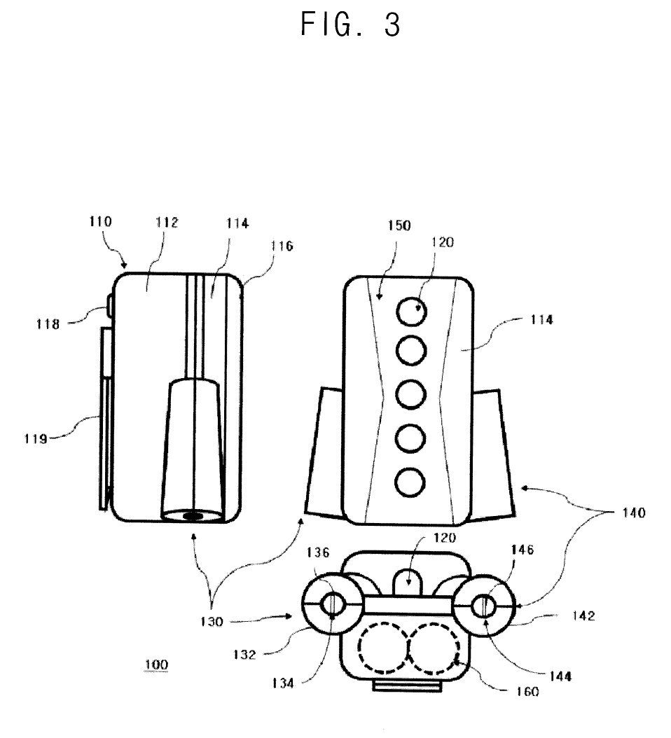

FIG. 3 is a view illustrating a light system for a bicycle in accordance with an example embodiment of the present inventive concept.

Referring to FIG. 3, the light system 100 for a bicycle may include a body 110, a first light source 120, a pair of second light sources 130 and 140, a circuit board 150 and a battery 160.

The body 110 may be shaped into a rectangular box and may include a main box 112, a reflection plate 114 and a transparent cover 116. A power switch 118 and a clip 119 may be installed to a rear side of the main body 112.

The body 110 may be detachably installed to a securing band of a seat frame of the bicycle by the clip 119.

The circuit board 150 and the battery 160 may be installed into the main body 112 and a front surface of the circuit board 150 may be covered with the reflection plate 114. Then, the transparent 116 may enclose a front portion of the main body 112. The first light source 120 may be positioned on a central portion of the circuit board 150. For example, five light emitting diodes (LED) may be arranged in a line on the central portion of the circuit board 150 as the first light source 150. A pair of the second light sources 130 and 140 may include a laser diode, respectively, and may be positioned at both side portions of the main body 112. In the present example embodiment, each of the second light sources 130 and 140 may be positioned in left and right cylinders 132 and 142, respectively. Each cylinder may include an exit hole 134 and 144 and a lens 136 and 146 may be installed into the exit hole 134 and 144. The laser beam generated from the laser diode may be irradiated through the lens 136 and 146, to thereby form the bike lane on the bicycle's riding surface. Particularly, the cylinders 132 and 142 may be inclined outwardly at an angle of about 5° to about 20° with respect to a vertical line penetrating through the riding surface, and thus the laser exiting from the exit holes 134 and 144 may be irradiated onto the riding surface obliquely outward with respect to a wheel of the bicycle. Therefore, the laser may be irradiated onto the riding surface with being spaced apart from the wheel of the bicycle. The laser from the laser diode may be formed into a linear beam by the lenses 136 and 146, and thus the linear beam may be irradiated onto the riding surface.

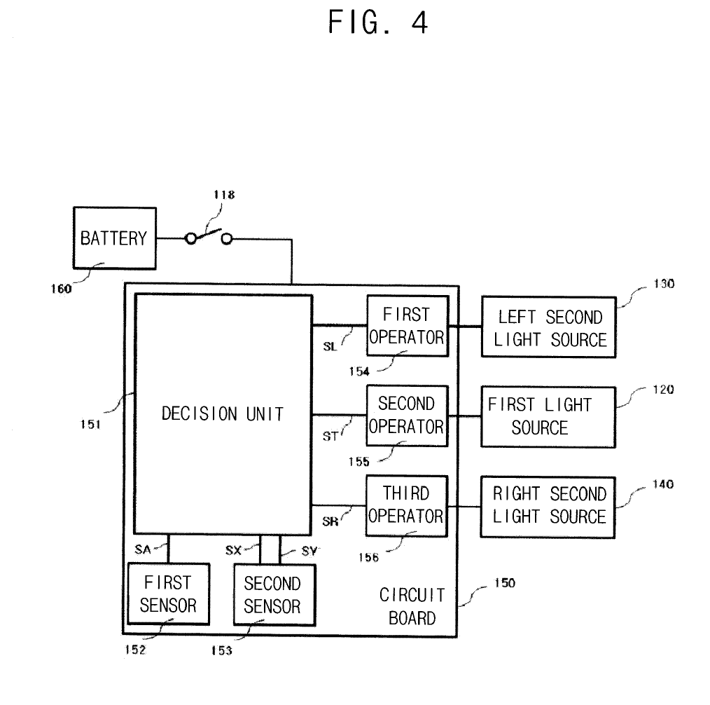

FIG. 4 is a block diagram showing a control circuit of the controller for operating the light system illustrated in FIG. 3.

Referring to FIG. 4, the circuit board 150 may include a decision unit 151, a first sensor 152 for detecting a stopping or a riding the bicycle, a second sensor 153 for detecting a moving direction of the bicycle, a first operator 154 for operating the left second light source 130, a second operator 155 for operating the first light source and a third operator 156 for operating the right second light source 140.

A driving power may be applied to each elements of the circuit board 150 from the battery 160 by the power switch 118.

The decision unit 151 may include a micro processor chip and a micro computer and may be operated according to a control algorithm that may be coded by a computer program for turning on/off the first light source and blinking or not the second light sources.

The first sensor 152 may detect the motion of the bicycle in response to the riding and the stationary mode and may include an inertial sensor, an acceleration sensor, a vibration sensor and a motion sensor, etc. A motion signal SA of the bicycle may be detected from the first sensor 152 and may be transferred to the decision unit 151.

The second sensor 153 may detect the direction of the riding bicycle. For example, the second sensor 153 may include a 2-dimensional or a 3-dimensional geomagnetic sensor and thus may detect the direction of the bicycle's motion in a Cartesian coordinate system. That is, the second sensor 153 may determine to which direction the bicycle rides between X-axis and Y-axis directions. An X-directional signal SX and a Y-directional signal may be detected from the second sensor 153 and may be transferred to the decision unit 151.

The first and the third operators 154 and 156 may receive first and third operating signals SL and SR from the decision unit 151 and may turn on/off and blink on/off the left and right second light sources 130 and 140 in accordance with the respective first and third operating signals SL and SR. For example, the left and the right second light sources may include a laser diode, respectively, and thus the laser diode may be turned on/off or blinked on/off by the first and the third operators 154 and 156.

The second operator 155 may receive a second operating signal ST from the decision unit 151 and may turn on/off the first light source 120 in accordance with the second operating signal ST. For example, the first light source 120 may include five LEDs arranged in a line and thus the LED line may be turned on/off by the second operator 155. Particularly, the LED line may experience various operation modes. For example, the five LEDs may be turned on/off in a simultaneous mode, a sequential mode and a clockwise or counterclockwise circulation mode.

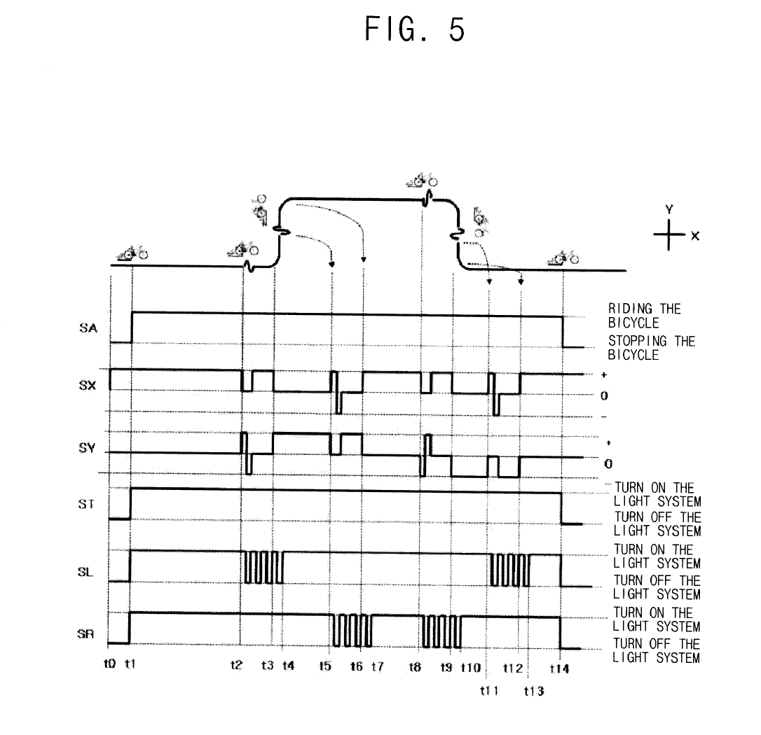

Hereinafter, a method of operating the light system 100 for a bicycle may be described in detail with reference to FIG. 5.

FIG. 5 is a timing flow diagram showing the operation of the control circuit of the controller for operating the light system of the bicycle.

Referring to FIG. 5, the power switch 118 may be turned on at an initial time t0 and the power may be applied to every operational element of the circuit board 150. Thus, the decision unit 151 may be initialized and the first and the second sensors 152 and 153 may start to detect the motion and direction signals of the bicycles. The detect signals by the first and the second sensors 152 and 153 may be transferred to the decision unit 151. At time t0, the motion signal SA indicating a stopping state of the bicycle may be detected by the first sensor 152 and the decision unit 151 may be initialized as the stopping motion signal SA. Thus, the decision unit 151 may control the first and the second light sources 120, 130 and 140 to remain inactive or turned-off in response to the stopping motion signal SA.

When the cyclist may start to ride the bicycle at time t1, the motion signal SA may be changed from a lower state, which may indicate the stopping state of the bicycle, to a higher state which may indicate a riding state of the bicycle. The motion signal SA of the riding state may be detected by the first sensor 152 and may be transferred to the decision unit 151. Then, the decision unit 151 may change the first operating signal SL, the second operating signal ST and the third operating signal SR from a lower state to a higher state. The first to the third operators 154 to 156 may operate the first and the second light sources 120, 130 and 140 to be active or turned on in response to the first operating signal SL, the second operating signal ST and the third operating signal SR.

When the cyclist may stop the bicycle at time t14, the motion signal SA may be changed from a lower state, which may indicate the stopping state of the bicycle, to a higher state which may indicate a riding state of the bicycle. The motion signal SA of the riding state may be detected by the first sensor 152 and may be transferred to the decision unit 151. Then, the decision unit 151 may change the first operating signal SL, the second operating signal ST and the third operating signal SR from a lower state to a higher state. The first to the third operators 154 to 156 may operate the first and the second light sources 120, 130 and 140 to be active or turned on in response to the first operating signal SL, the second operating signal ST and the third operating signal SR.

Therefore, the light system 100 may be automatically controlled in response to the riding or stopping of the bicycle without manual operation, to thereby facilitate riding the bicycle and reducing the power consumption for operating the light system 100.

In addition, when the bicycle may stop accidentally or unexpectedly, the laser from the second light sources 130 and 140 may be immediately stopped the irradiation by the first sensor 152 and the decision unit 151. Therefore, when the bicycle may be fallen down accidentally, the light system 100 may sufficiently reduce the damages to the eyes of the passers-by caused by the laser.

The second light sources may function as the turn indicators according to the following algorithms.

Referring to FIG. 5, when the cyclist may turn to the left at time t2 and then immediately to the right just like a zigzag motion so as to turn on the left turn indicator, the second sensor 153 may detect the X-directional signal SX and the Y-directional signal corresponding to the left turning motion and may transfer the signals SX and SY to the decision unit 151. Then, the X-directional signal SX may be changed into a zero state from the higher state and the Y-directional signal may be changed into the higher state from the zero state in the decision unit 151. The variation combination [0, H] of the signals SX and SY may function as a first blinking signal for the first operator 154. Thus, the decision unit 151 may generate the first operating signal SL as the first blinking signal and the first operator 154 may operate the left second light source 130 to be blinked in response to the first operating signal SL. That is, the left second light source 130 may function as the left turn indicator when the cyclist may turn to the left.

When the cyclist may continue the riding of the bicycle without any directional variation such as the zigzag motion after completing the leftward turning at time t3 for a preset time, no changes of the signals SX and SY may be transferred to the decision unit 151 and the decision unit 151 may determine the bicycle may ride forward without any changes of direction. Therefore, when elapsing the preset time, the decision unit 151 may control the left second light source 130 to stop blinking and to maintain the turn-on state.

In contrast, when the cyclist may turn to the right at time t5 and then immediately to the left just like the zigzag motion so as to turn on the right turn indicator, the second sensor 153 may also detect the X-directional signal SX and the Y-directional signal corresponding to the right turning motion and may transfer the signals SX and SY to the decision unit 151. Then, the X-directional signal SX may be changed into the higher state from the zero state and the Y-directional signal may be changed into the zero state from the higher state in the decision unit 151. The variation combination [H, 0] of the signals SX and SY may function as a second blinking signal for the third operator 156. Thus, the decision unit 151 may generate the third operating signal SR as the second blinking signal and the third operator 156 may operate the right second light source 140 to be blinked in response to the third operating signal SR. That is, the right second light source 140 may function as the right turn indicator when the cyclist may turn to the right.

When the cyclist may continue the riding of the bicycle without any directional variation such as the zigzag motion after completing the rightward turning at time t6 for a preset time, no changes of the signals SX and SY may be transferred to the decision unit 151 and the decision unit 151 may determine the bicycle may ride forward without any changes of direction. Therefore, when elapsing the preset time, the decision unit 151 may control the right second light source 140 to stop blinking and to maintain the turn-on state.

When the cyclist may turn again to the right at time t8 and then immediately to the left just like the zigzag motion so as to turn on the right turn indicator again, the second sensor 153 may also detect the X-directional signal SX and the Y-directional signal corresponding to the additional right turning motion and may transfer the signals SX and SY to the decision unit 151. Then, the X-directional signal SX may be changed into the zero state from the higher state and the Y-directional signal may be changed into the lower state from the zero state in the decision unit 151. The variation combination [0, L] of the signals SX and SY may function as a third blinking signal for the third operator 156. Thus, the decision unit 151 may generate the third operating signal SR as the third blinking signal and the third operator 156 may operate the right second light source 140 to be blinked in response to the third operating signal SR. That is, the right second light source 140 may function as the right turn indicator when the cyclist may turn to the right.

When the cyclist may continue the riding of the bicycle without any directional variation such as the zigzag motion after completing the additional rightward turning at time t9 for a preset time, no changes of the signals SX and SY may be transferred to the decision unit 151 and the decision unit 151 may determine the bicycle may ride forward without any changes of direction. Therefore, when elapsing the preset time, for example, at time t10, the decision unit 151 may control the right second light source 140 to stop blinking and to maintain the turn-on state.

When the cyclist may turn again to the left at time t11 and then immediately to the right just like a zigzag motion so as to turn on the left turn indicator again, the second sensor 153 may detect the X-directional signal SX and the Y-directional signal corresponding to the additional left turning motion and may transfer the signals SX and SY to the decision unit 151. Then, the X-directional signal SX may be changed into the higher state from the zero state and the Y-directional signal may be changed into the zero state from the lower state in the decision unit 151. The variation combination [H, 0] of the signals SX and SY may function as a fourth blinking signal for the first operator 154. Thus, the decision unit 151 may generate the first operating signal SL as the fourth blinking signal and the first operator 154 may operate the left second light source 130 to be blinked in response to the first operating signal SL. That is, the left second light source 130 may function as the left turn indicator when the cyclist may turn to the left.

When the cyclist may continue the riding of the bicycle without any directional variation such as the zigzag motion after completing the additional leftward turning at time t12 for a preset time, no changes of the signals SX and SY may be transferred to the decision unit 151 and the decision unit 151 may determine the bicycle may ride forward without any changes of direction. Therefore, when elapsing the preset time, for example at time t13, the decision unit 151 may control the left second light source 130 to stop blinking and to maintain the turn-on state.

Accordingly, the variation combinations of the signals SX and SY may be listed as follows at the moments of starting and completing the turning motion, respectively.

TABLE 1

| | | Starting | | Completing | |
|---|---|---|---|---|---|
| | | turning motion | | turning motion | |
| | | SX | SY | SX | SY |
| Moving along +X | Turning left | [symbol] | [symbol] | +0 | + |
| direction | Turning right | [symbol] | [symbol] | +0 | − |
| Moving along −X | Turning left | [symbol] | [symbol] | −0 | − |
| direction | Turning right | [symbol] | [symbol] | −0 | + |
| Moving along +Y | Turning left | [symbol] | [symbol] | − | +0 |
| direction | Turning right | [symbol] | [symbol] | + | +0 |
| Moving along −Y | Turning left | [symbol] | [symbol] | + | −0 |
| direction | Turning right | [symbol] | [symbol] | − | −0 |

The variation combinations of the signals SX and SY as listed in Table 1 may be transferred into the decision unit 151 and the decision unit 151 may determine whether the bicycle may start the turning motion or may complete the turning motion.

According to the example embodiments of the present inventive concepts, the first and the third operating signals SL and SR may be automatically generated in accordance with the moving direction and the zigzag motion of the bicycle, and thus the left and the right second light sources 130 and 140 may automatically function as the left and the right turn indicators, respectively, without any additional manual operations, to thereby facilitate the bicycle's riding and prevent safety accidents at night.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A light system for a bicycle, comprising:
a body detachably installed to a frame of the bicycle;
at least a battery installed in the body;
a first light source positioned at a central portion of the body and shining a flashlight to a rear side of the bicycle;
a second light source positioned at a side portion of the body and shining a light beam displaying a bicycle lane on a riding surface of the bicycle;
a sensor installed in the body and detecting a stop or a riding of the bicycle; and
a controller installed in the body and controlling the first and the second light sources in accordance with the sensor in such a manner that at least one of the first and the second light sources is turned on in riding the bicycle and is turned off in stopping the bicycle.

2. The light system for a bicycle of claim 1, wherein the sensor includes an inertial sensor, an acceleration sensor, a vibration sensor and a motion sensor.

3. A light system for a bicycle, comprising:
a body detachably installed to a frame of the bicycle;
at least a battery installed in the body;
a first light source positioned at a central portion of the body and shining a flashlight to a rear side of the bicycle;
a pair of left and right second light sources positioned at both side portions of the body and shining a light beam displaying a bicycle lane on a riding surface of the bicycle;
a geomagnetic sensor built in the body and detecting a turning of the bicycle leftwards or rightwards; and
a controller installed in the body and controlling the second light sources in accordance with the geomagnetic sensor in such a manner that one of the left and right second light sources blinks according to a turning direction when the bicycle turns leftwards or rightwards and stops to blink and shines the light beam displaying the bicycle lane when the bicycle completes the leftward or rightward turning.

4. A light system for a bicycle, comprising:
a body detachably installed to a frame of the bicycle;
at least a battery installed in the body;
a first light source positioned at a central portion of the body and shining a flashlight to a rear side of the bicycle;
a pair of left and right second light sources positioned at both side portions of the body and shining a light beam displaying a bicycle lane on a riding surface of the bicycle;
a first sensor built in the body and detecting a stopping or a riding of the bicycle;
a second sensor built in the body and detecting a moving direction of the bicycle; and
a controller installed in the body and controlling the first and the second light sources in accordance with the first and the second sensors in such a manner that at least one of the first and the second light sources is turned on in riding the bicycle and is turned off in stopping the bicycle and one of the left and right second light sources blinks according to a turning direction when the bicycle turns leftwards or rightwards and stops to blink and shines the light beam displaying the bicycle lane when the bicycle completes the leftward or rightward turning.

5. The light system for a bicycle of claim 4, wherein the first sensor includes an inertial sensor, an acceleration sensor, a vibration sensor and a motion sensor.

6. The light system for a bicycle of claim 4, wherein the second sensor includes a geomagnetic sensor.

7. A light system for a bicycle, comprising:
a body detachably installed to a frame of the bicycle;
at least a battery installed in the body;
a pair of turn indicators positioned at both side portions of the body and creating a turn signal according to a turning of the bicycle leftwards or rightwards;
a directional sensor built in the body and detecting the turning of the bicycle leftwards or rightwards; and
a controller installed on a control circuit board in the body and controlling the turn indicators in accordance with the directional sensor in such a manner that one of the turn indicators blinks according to a turning direction when the bicycle turns leftwards or rightwards and stops to blink and shines a light beam at a rear side of the bicycle when the bicycle completes the leftward or rightward turning.

8. A method of controlling a light system for a bicycle, comprising:
detecting a moving direction of the bicycle by a sensor;
detecting a direction change with respect to the moving direction of the bicycle by the sensor;
generating a control signal corresponding to the direction change by a controller;
blinking a respective turn indicator according to the control signal; and
stopping the blinking of the respective turn indictor and shining a light beam to a rear side of the bicycle when the direction change of the bicycle is not detected for a predetermined time by the sensor.
